(19) United States
(12) Patent Application Publication
(10) Pub. No.: US 2026/0301700 A1
(43) Pub. Date: Oct. 1, 2026

(54) A BACKLIGHT UNIT, A VEHICLE DISPLAY APPARATUS AND A METHOD OF CONTROLLING THE SAME

(71) Applicant: AUMOVIO Germany GmbH, Frankfurt am Main (DE)

(72) Inventors: Martin Thomas NOWAK, Singapore (SG); Ting XIAO, Singapore (SG); Manrico JOSEPH, Ober-Ramstadt (DE); Sait KALENDER, Darmstadt (DE); Sascha KAYSSER, Maintal (DE); Martin JEKEL, Bad Nauheim (DE)

(21) Appl. No.: 19/478,400

(22) PCT Filed: Apr. 16, 2024
(86) PCT No.: PCT/EP2024/060230

§ 371 Date: Oct. 24, 2025

(30) Foreign Application Priority Data
Apr. 27, 2023 (GB) 2306183.1

(51) Int. Cl. G09G 3/34; B60K 35/22; B60K 35/234; B60K 35/81; G02F 1/1335; G02F 1/13357; G02F 1/139; H05B 45/325

(52) U.S. Cl. CPC G09G 3/342; B60K 35/22; B60K 35/234; B60K 35/81; G02F 1/133605; G02F 1/133612; G02F 1/1396; H05B 45/325; B60K 2360/349; G02F 1/133603; G09G 2300/026; G09G 2310/04; G09G 2380/10

(57) ABSTRACT

A backlight unit for a vehicle display apparatus having: modular lighting units operable to illuminate light beams, each modular lighting unit is operable to interconnect to form an illumination zone of the backlight unit. Each modular lighting unit includes: a housing; and an illumination source in electrical connection with a circuit board. The illumination source is arranged within the housing. A vehicle display apparatus has a display layer; a backlight unit, the backlight unit supplies light beams through the display layer; and a processing unit executes instructions to send pulse width modulation (PWM) signals to the backlight unit to illuminate the light beams through the display layer. The processing unit executes the instructions to send PWM signals to control a percentage of brightness an illumination zone of the backlight unit illuminating through the display layer.

### CROSS REFERENCE TO RELATED APPLICATIONS

This is a U.S. national stage of Application No. PCT/EP2024/060230 filed Apr. 16, 2024. Priority is claimed on Great Britain Patent Application No. GB 2306183.1 filed Apr. 27, 2023, the contents of which are incorporated herein by reference.

### BACKGROUND OF THE INVENTION

### 1. Field of the Invention

This disclosure relates a backlight unit for vehicle display apparatus, and more in particular a backlight unit comprising multiple modular lighting units, and a method of controlling the same.

### 2. Description of the Related Art

A display apparatus is commonly used in automotive industry for displaying vehicular information. A display apparatus includes an illumination source to transmit light rays towards a viewer, such that information displayed can be viewed on the displays screen. In operation, the illumination source generates heat and only 40% of electrical power is converted to light rays. The remaining 60% of electrical power is dissipated as heat. In automotive applications, temperature of an operating display apparatus has an ambient temperature of 85 °C.

High thermal temperature causes expansion of components which affects optical performance loss, as well as tolerance issues, mechanical stress, collision and displacement within the components, in particular for large displays. Therefore, efficient thermal management to avoid overheating of display systems is crucial to prevent damage to the display systems.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF THE INVENTION

A purpose of this disclosure is to ameliorate the problem of caused by mechanical stress and thermal issues in digital displays, in particular digital vehicle display apparatus as discussed above.

The objective of this disclosure is solved by a backlight unit for a vehicle display apparatus comprising:
one or more modular lighting units operable to illuminate light beams, wherein
each of the modular lighting unit is operable to interconnect to form at least one illumination zone of the backlight unit.
characterized in that:
   each of the modular lighting unit further comprises:
      a housing; and
      an illumination source in electrical connection with a circuit board, wherein the illumination source is arranged within the housing.

An advantage of the above described aspect of this disclosure yields a single backlight unit using miniaturised opto-mechanical components which is modular and adaptable to different display apparatus size. In addition, short tolerance chains cause by heat during operation is expected within different illumination zones of a single backlight unit. Since multiple illumination zones are defined on a single unit by the modular lighting units, another advantage of the aforesaid backlight unit configuration achieves precise control of at least one illumination zone to multiple or X illumination zones.

Preferred is a backlight unit as described above or as described above as being preferred, in which:
the housing comprises at least one segmentation wall.

The advantage of the above aspect of this disclosure is to provide a housing with at least one segmentation wall such that when the modular light units are interconnected, one or more cavities are formed by virtue of the interconnection of the at least one segmentation wall, thereby forming up to four-sided housing with a cavity within. The illumination sources are isolated and arranged within the at least one segmentation wall of the housing.

Preferred is a backlight unit as described above or as described above as being preferred, in which:
the at least one segmentation walls comprise four segmentation walls.

The advantage of the above aspect of this disclosure is to utilize parts of the housing of the modular lighting unit as partition or segmentation wall such that each illumination source supplies light beam through the housing it is arranged within a cavity formed by the four segmentation walls. Preferably, the number of the segmentation walls is understood to be in even numbers, for example, two segmentation walls or four segmentation walls, to form a housing with a cavity within, to house the illumination source, although not limited thereto. More advantageously, precise control of each illumination source can be achieved.

Preferred is a backlight unit as described above or as described above as being preferred, in which:
each of the at least one segmentation walls of the housing has a curved surface.

The advantage of the above aspect of this disclosure is to achieve highest degree of light control and optimization of light beams towards specific spatial direction using curved segmentation walls.

Preferred is a backlight unit as described above or as described above as being preferred, in which:
the segmentation walls of the housing have a substantially flat surface.

The advantage of the above aspect of this disclosure is to achieve light control and optimization of light beams towards specific spatial direction using flat segmentation walls.

Preferred is a backlight unit as described above or as described above as being preferred, in which:
the segmentation walls further comprise a reflective coating.

The advantage of the above aspect of this disclosure is to achieve high reflectivity of the segmentation walls, to optimize control or direct light beams towards specific spatial direction.

Preferred is a backlight unit as described above or as described above as being preferred, in which:
each of the modular lighting unit further comprises an optical state layer on a side opposite to the circuit board.

The advantage of the above aspect of this disclosure is to provide a modular lighting unit with optimized optical performance. In addition, a low refractive index material may be used to adhere the optical layer to a side of the modular lighting unit opposite to the circuit board, reduce fraction of adjacent zones.

The objective of this disclosure is solved by a vehicle display apparatus comprising:
a display layer;
a backlight unit as defined in accordance with the backlight unit as defined above, the backlight unit operable to supply light beams through the display layer; and
a processing unit operable to execute a set of instructions to send pulse width modulation (PWM) signals to the backlight unit to supply the light beams through the display layer,
characterized in that:
   the backlight unit comprises one or more modular lighting units, each of the modular lighting unit is operable to interconnect to form at least one illumination zone of the backlight unit, and
   the processing unit is further operable to execute the set of instructions to send PWM signals to control a percentage of brightness of the at least one illumination zone of the backlight unit illuminating through the display layer.

An advantage of the above-described aspect of this disclosure yields a vehicle display apparatus using the backlight unit as defined above, to provide one or more illumination zone which is controlled by a processing unit. More advantageously, the backlight unit is constructed using multiple modular lighting units, thus providing flexibility in design specification. Each illumination zone has short tolerance chain and the ability to control each illumination zone according to different percentages of brightness is possible to achieve local diming effects.

Preferred is a vehicle display as described above or as described above as being preferred, in which:
the display layer is a twisted nematic display layer.

The advantage of the above aspect of this disclosure is to provide a vehicle display apparatus incorporated with the backlight unit as disclosed herein, which has lower power consumption, thus addressing the issue of thermal management of display technologies in motor vehicles as discussed above.

Preferred is a vehicle display as described above or as described above as being preferred, in which:
the processing unit is further operable to execute the set of instructions to simultaneously adjust
   a RGB value of the display layer;
   and
   a pulse width modulation (PWM) value of the backlight unit, of each of the at least one illumination zone.

The advantage of the above aspect of this disclosure is to achieve local dimming effects of each illumination zone when in operation. Advantageously, different content can be displayed at different areas of the vehicle display apparatus.

Preferred is a vehicle display as described above or as described above as being preferred, in which:
the processing unit is further operable to execute the set of instructions to send PWM signals to control
   a percentage of brightness of a first illumination zone of the backlight unit illuminating through the display layer; and
   a percentage of brightness of a second illumination zone of the backlight unit illuminating through the display layer,
wherein
   the percentage of brightness of the first illumination zone is a value different from the percentage of brightness of the second illumination zone.

The advantage of the above aspect of this disclosure is to yield a vehicle display apparatus with a backlight unit which allows different illumination zone to display different content, at different percentage of brightness. Consequently, this feature also influences total power consumption of the vehicle display apparatus.

Preferred is a vehicle display as described above or as described above as being preferred, in which:
the vehicle display apparatus is selected from a group consisting of:
   in-vehicle display apparatus;
   in-vehicle digital cluster;
   head-up display,
and combination thereof.

The advantage of the above aspect of this disclosure is to provide a backlight unit constructed from multiple modular lighting unit adaptable to different types of in-vehicle display apparatus which addresses the drawback of display apparatus operating at high temperatures within a motor vehicle as discussed above.

The objective of this disclosure is solved by a method of illuminating a vehicle display apparatus:
supplying, by way of a backlight unit, light beams through a display layer of a vehicle display apparatus;
and
   executing, by way of a processing unit, a set of instructions for sending pulse width modulation (PWM) signals to the backlight unit for supplying the light beams through the display layer,
characterized by that:
   at least one illumination zone the backlight unit further comprises at least one illumination zone formed by interconnecting one or more modular lighting units, and
   controlling, by way of the processing unit, a percentage of brightness of the at least one illumination zone of the back light unit illuminating though the display layer.

An advantage of the above described aspect of this disclosure yields a method of controlling a vehicle display vehicle display apparatus using the backlight unit as defined above, to provide one or more illumination zone which is controlled by a processing unit. More advantageously, the backlight unit is constructed using multiple modular lighting units, thus providing flexibility in design specification. Each illumination zone has short tolerance chain and the ability to control each illumination zone according to different percentages of brightness is possible to achieve local diming effects.

The objective of this disclosure is solved by a computer program comprising instructions which, when the program is executed by a computer, cause the computer to carry out the method as described herein.

An advantage of the above described aspect of this disclosure yields a software program or a computer program suitable for controlling a backlight unit or a vehicle display apparatus having a backlight unit as disclosed herein.

The objective of this disclosure is solved by a computer-readable medium having stored thereon the computer program product as described herein.

An advantage of the above described aspect of this disclosure yields a computer-readable medium having a computer program as disclosed stored thereon, for controlling a backlight unit or a vehicle display apparatus having a backlight unit as disclosed herein.

Other objects, features and characteristics, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific embodiments, while indicating the non-limiting embodiments of the disclosure, are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a top view and cross-section view of a modular lighting unit as disclosed herein;

FIG. 2 is a top-view and a cross-section view of a backlight unit as disclosed herein;

FIG. 3 is a cross-section view of a vehicle display apparatus as disclosed herein; and

FIG. 4 is a displaying view a vehicle display apparatus as disclosed herein.

### DETAILED DESCRIPTION OF THE PRESENTLY PREFERRED EMBODIMENTS

It should be understood that like reference numerals identify corresponding or similar elements throughout the several drawings.

In the context herein, the term “curved surface” refers to spherical, A-spherical or parabolic shaped surface.

### Modular Lighting Unit 100

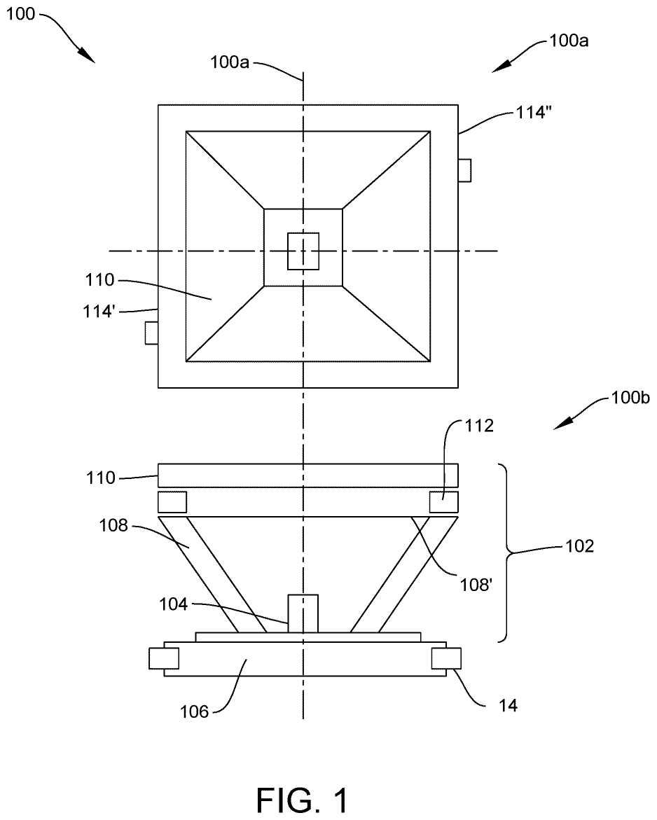

Referring to the accompanying drawings, FIG. 1 shows top view and cross-section view of a modular lighting unit 100 as disclosed herein. As shown in FIG. 1, modular lighting unit 100 up to four segmentation walls 108, 108′ as shown in the cross-section view, is required to construct a single modular lighting unit 100, to form a housing 102 having a cavity within, such that an illumination source 104 is arranged within the housing 102, although not limited thereto. An embodiment of illumination source is a light emitting diode (LED). As shown in FIG. 1, the segmentation walls 108, 108′ have substantially flat surface. The segmentation wall can be made of plastic or rubber. A layer of reflective coating (not shown) may be applied to the segmentation wall surface facing the illumination source 104 to increase reflectivity of the light beams transmitting from the illumination source 104. An advantage of the aforesaid configuration is to achieve high reflectivity of the segmentation walls, to optimize control or direct light beams towards specific spatial direction.

Each illumination source 104 of the modular lighting unit 100 is electrically connected to a circuit board for supplying power to illuminate light beams. An embodiment of a circuit board includes printed circuit board (PCB), which may include white print or without white print as desired. An optical stack layer 110 may be displaced at side opposite to the circuit board 106. Suitable optical stack layer 110 includes micro lens array or foil. The optical stack layer 110 can be adhered to one or more edges of the segmentation wall 108, 108′ using a low refractive index material. An advantage of using a low refractive index material as the adhesive is achieve reduction of refraction of adjacent lighting zones.

### Backlight Unit 200

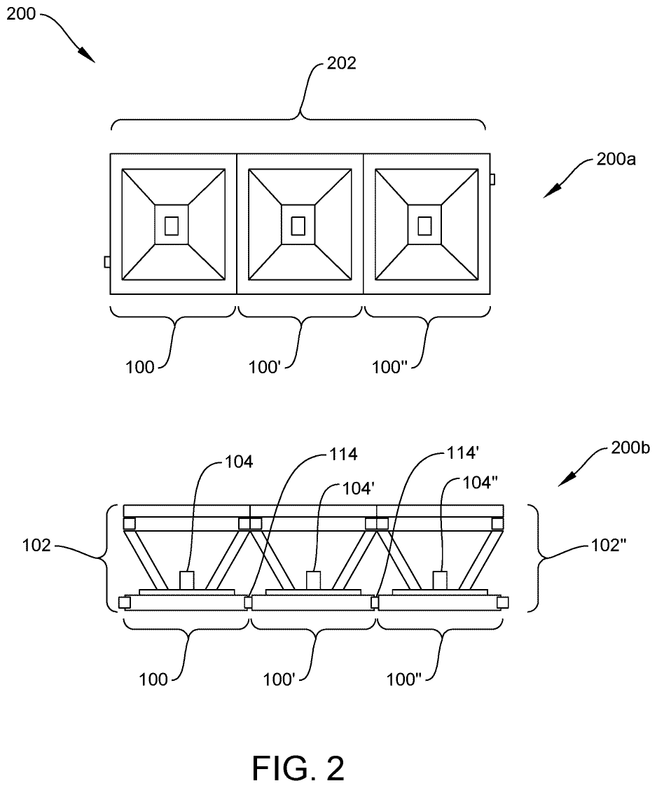

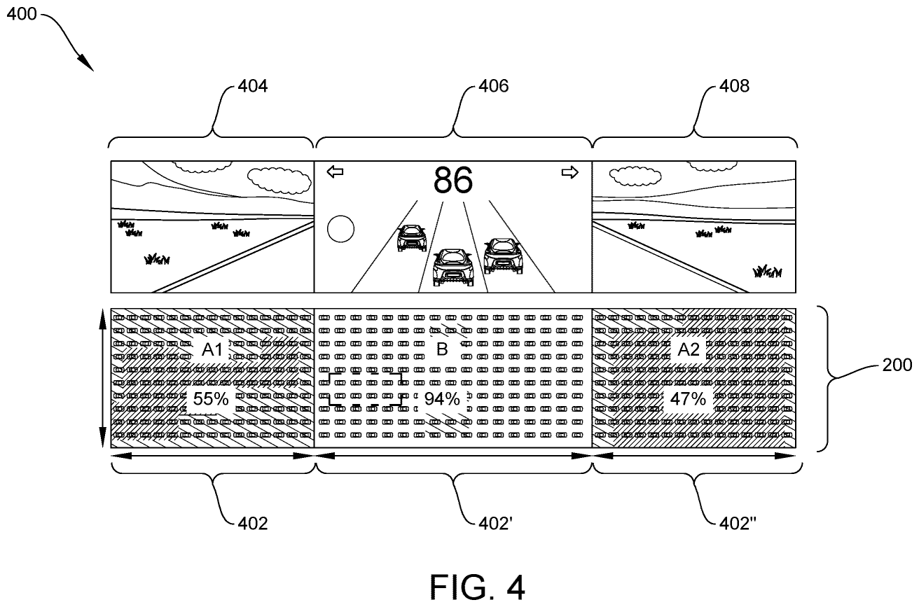

FIG. 2 shows top-view and a cross-section view of a backlight unit 200 as disclosed herein. As seen from the top view and the cross-section view, backlight unit 200 comprises modular lighting unit 100, 100′, 100″ displaced adjacently and interconnecting to each other. An embodiment of interconnection means is a connector 114 between different circuit boards 106, 106′, 106″ of the modular lighting units 100, 100′, 100″. The illumination source 104, 104′, 104″ supplies light beams through the respective cavity or housing 102 which it is arranged in. Multiple modular lighting units 100, 100′, 100″ are interconnected to form an illumination zone (FIG. 4 referred).

In another aspect, a modular lighting unit 100 may have at least one segmentation wall 108, and when connected to two adjacent modular lighting unit 100′, a third segmentation wall and a fourth segmentation wall is formed to construct a full backlight unit.

A main advantage of this disclosure is ability to interconnect the modular lighting unit 100 to form a backlight unit, which allows multiple illumination zone by controlling each modular lighting and the circuit board 106 may include interconnectors 114 for interconnecting each modular lighting unit 100 to form a backlight unit 200. By using miniaturized opto-mechanical element, specifically modular lighting unit 100 as disclosed above allows adaptability to design backlight units to cater to different display apparatus size. The manufacturing process of smaller component is also more cost efficient over bulky components in terms of material and logistic costs.

Further advantages include short tolerance chains, as compared to conventional backlight units, of which tolerance chains are caused by heat during operation is expected within different illumination zones of a single backlight unit. Thermal issue is often caused by high power consumption rate, which is a challenge in motor vehicle environment, as discussed above. Since multiple illumination zones are defined on a single unit by the modular lighting units, another advantage of the aforesaid backlight unit configuration achieves precise control of at least one illumination zone to multiple or X number of illumination zones.

### Cross-Section View of Vehicle Display Apparatus 300

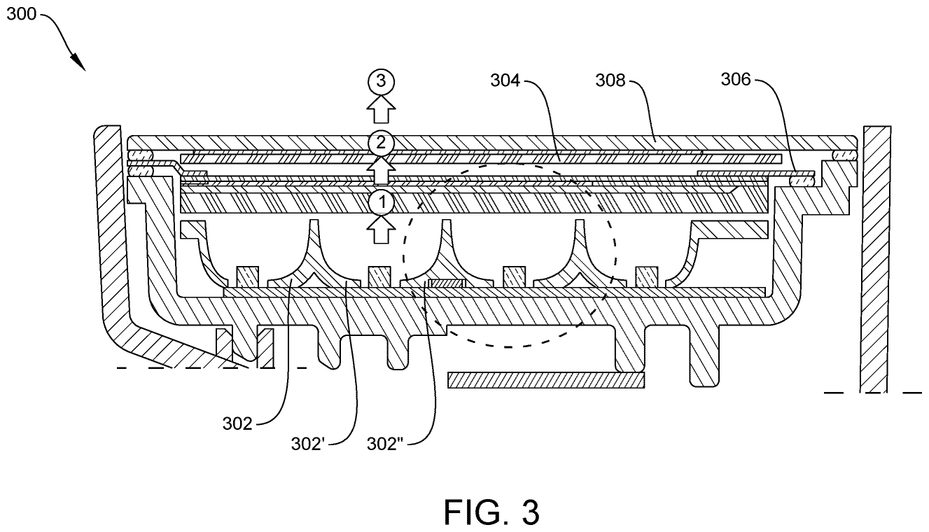

FIG. 3 shows a cross-section view of a vehicle display apparatus 300 as disclosed herein. Vehicle display apparatus 300 includes a backlight unit 200 constructed with one or more modular lighting units 100, 100′, 100″. In this aspect, the segmentation walls 302, 302′, 302″ have curved surface. An advantage of a curved segmentation wall is to achieve highest degree of light beam control and optimization of light beams towards specific spatial direction. Similar to the previous example of substantially flat surface, a reflective coating may be applied to the segmentation wall facing the illumination source 104.

The vehicle apparatus 300 includes a display layer 304 to display content to a user, when in operation. Preferably, the display layer 304 is a twisted nematic display. Examples of TN display includes liquid crystal display (LCD) and thin film transistor (TFT), although not limited thereto.

Other elements such as cover glass, optically clear adhesive (OCA) and retainer may include in the vehicle display apparatus 300, depending on the design requirements, but removal of the aforesaid elements do not affect the technical advantages of the main inventive concept of this disclosure.

### Displaying View of Vehicle Apparatus 400

FIG. 4 shows displaying view a vehicle display apparatus 400 as disclosed herein and a corresponding view of the backlight unit 200. The backlight unit 200 is defined according to at least one illumination zone 402. In this exemplary embodiment as shown in FIG. 4, the illumination zones are defined as 402, 402′, 402″, with corresponding Content A 404, Content B 406 and Content C 408 representative of the images displayed on the display layer 304 when in operation.

For a complete system, a processing unit (not shown) having a computer program stored thereon, operable to execute a set of instructions to send pulse width modulation (PWM) signals to the backlight unit 200 is in communication with the vehicle display apparatus 300, 400 to illuminate the light beams through to the display layer 304. The processing unit is further operable to execute the set of instructions to send PWM signals to control a percentage of brightness of at least one illumination zone of the backlight unit illuminating through the display layer 304.

The processing unit is further operable to execute the set of instructions to simultaneously adjust a RGB value of the display layer and a pulse width modulation (PWM) value of the backlight unit 200.

Referring back to FIG. 4, it can be seen that the displayed content, Content A 404, Content B 406 and Content C 408 are displayed with a different percentage of brightness. The processing unit is operable to control a percentage of brightness of different illumination zones, for example, a first illumination zone 402 of the backlight unit illuminating through the display layer 304 has a different value in terms of percentage of brightness from a second illumination zone 402′ of the backlight unit 200 illuminating. In this given example, a percentage of brightness of a first illumination zone 402 of the backlight unit illuminating through the display layer 304 has a different percentage in terms of percentage of brightness compared to a second illumination zone 402′ of the backlight unit 200 illuminating through the display layer 304 displaying different contents. This can be controlled by the processing unit which to execute the set of instructions to send PWM signals to control the percentage of brightness of the first illumination zone 404 to 55%, while the percentage of brightness of the second illumination zone 402′ is at 94%. In this given example, a third illumination zone 402″ has a percentage of brightness passing through the display layer 304, displaying Content C at a percentage of brightness at 47%. Hence the effect is such that when a viewer views the contents from a viewing side of the vehicle display apparatus 300, 400, different display zones have different level of brightness. Advantageously, this achieve local dimming effects of each illumination zone when in operation, such that different content can be displayed at different areas of the vehicle display apparatus.

The term “processing unit” used herein may broadly encompass a general-purpose processor, a central processing unit (CPU), a microprocessor, a digital signal processor (DSP), a controller, a microcontroller, a state machine, and so forth. Under some circumstances, a “processing unit” may refer to an application specific integrated circuit (ASIC), a programmable logic device (PLD), a field programmable gate array (FPGA), etc. The term “processing unit” may refer to a combination of processing devices, e.g., a combination of a DSP and a microprocessor, a plurality of microprocessors, one or more microprocessors in conjunction with a DSP core, or any other such configuration. The “processing unit” may include a memory, for loading a sequence of instruction, causing the “processing unit” to perform steps of actions. The term “memory” should be interpreted broadly to encompass any electronic component capable of storing electronic information. The term “memory” may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. “Memory” is said to be in electronic communication with a processor if the processor can read information from and/or write information to the memory. Memory that is integral to a processor is in electronic communication with the processor. Henceforth, the term “processing unit” may also be taken to encompass “system on chip” (SoC) which uses a single integrated circuit (IC) chip that contains multiple resources, computational units, processors and/or cores integrated on a single substrate. A single SOC may contain circuitry for digital, analog, mixed-signal, and radio-frequency functions, as well as any number of general purpose and/or specialized processors (digital signal processors, modem processors, video processors, etc.), memory blocks (e.g., ROM, RAM, Flash, etc.). Unless otherwise specifically stated, the “processing unit” is not limited to any specific combination of hardware circuitry and software, nor to any particular source for the instructions executed by the processing unit.

The foregoing description shall be interpreted as illustrative and not be limited thereto. One of ordinary skill in the art would understand that certain modifications may come within the scope of this disclosure. Although the different non-limiting embodiments are illustrated as having specific components or steps, the embodiments of this disclosure are not limited to those combinations. Some of the components or features from any of the non-limiting embodiments may be used in combination with features or components from any of the other non-limiting embodiments. For these reasons, the appended claims should be studied to determine the true scope and content of this disclosure.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A backlight unit for a vehicle display apparatus comprising:
one or more modular lighting units operable to illuminate light beams, each of the one or more modular lighting units is operable to interconnect to form at least one illumination zone of the backlight unit;
wherein:
each of the modular lighting unit further comprises:
a housing; and
an illumination source arranged within the housing and in electrical connection with a circuit board.

17. The backlight unit according to claim 16, wherein the housing comprises at least one segmentation wall.

18. The backlight unit according to claim 17, wherein the at least one segmentation wall comprises four segmentation walls.

19. The backlight unit according to claim 18, wherein each of the segmentation walls of the housing has a curved surface.

20. The backlight unit according to claim 18, wherein each of the segmentation walls of the

21. The backlight unit according to claim 17, wherein the at least one segmentation wall further comprises a reflective coating.

22. The backlight unit according to claim 16, wherein each modular lighting unit further comprises an optical state layer on a side opposite to the circuit board.

23. A vehicle display apparatus comprising:
a display layer;
a backlight unit configured to supply light beams through the display layer comprising:
one or more modular lighting units operable to illuminate light beams, each of the one or more modular lighting units is operable to interconnect to form at least one illumination zone of the backlight unit;
wherein:
each of the modular lighting unit further comprises:
a housing; and
an illumination source arranged within the housing and in electrical connection with a circuit board; and
a processing unit operable configured to:
execute a set of instructions to send pulse width modulation (PWM) signals to the backlight unit to illuminate the light beams through the display layer, and
execute the set of instructions to send PWM signals to control a percentage of brightness of at least one illumination zone of the backlight unit illuminating through the display layer.

24. The vehicle display apparatus according to claim 23, wherein the display layer is a twisted nematic display layer.

25. The vehicle display apparatus according to claim 23, wherein the processing unit is further operable to execute the set of instructions to simultaneously adjust for each of the at least one illumination zone:
a RGB value of the display layer; and
a pulse width modulation (PWM) value of the backlight unit.

26. The vehicle display apparatus according to claim 23, wherein the processing unit is further operable to execute the set of instructions to send PWM signals to control:
a percentage of brightness of a first illumination zone of the backlight unit illuminating through the display layer; and
a percentage of brightness of a second illumination zone of the backlight unit illuminating through the display layer,
wherein the percentage of brightness of the first illumination zone is a value different from the percentage of brightness of the second illumination zone.

27. The vehicle display apparatus according to claim 24, wherein the vehicle display apparatus is selected from a group consisting of:
in-vehicle display apparatus;
in-vehicle digital cluster;
head-up display; and
combination thereof.

28. A method of illuminating a vehicle display apparatus comprising:
supplying, by way of a backlight unit, light beams for illuminating through a display layer of a vehicle display apparatus;
executing, by way of a processing unit, a set of instructions for sending pulse width modulation (PWM) signals to the backlight unit, for illuminating light beams from the through the display layer;
providing, by way of the backlight unit, at least one illumination zone formed by interconnecting one or more modular lighting units, each of the one or more modular lighting units having an illumination source arranged therein; and
controlling, by way of the processing unit, a percentage of brightness of the at least one illumination zone of the backlight unit illuminating though the display layer.

29. A computer program stored on a nontransitory computer-readable medium having comprising instructions which, when the program is executed by a computer, causes the computer to cause a vehicle display apparatus to:
supply, by way of a backlight unit, light beams for illuminating through a display layer of a vehicle display apparatus;
execute, by way of a processing unit, a set of instructions for sending pulse width modulation (PWM) signals to the backlight unit, for illuminating light beams from the through the display layer;
provide, by way of the backlight unit, at least one illumination zone formed by interconnecting one or more modular lighting units, each of the one or more modular lighting units having an illumination source arranged therein; and
control, by way of the processing unit, a percentage of brightness of the at least one illumination zone of the backlight unit illuminating though the display layer.
